(19) United States
(12) Patent Application Publication
(10) Pub. No.: US 2021/0315422 A1
(43) Pub. Date: Oct. 14, 2021

(54) SANDWICH TONG AND METHOD FOR PREPARING A WET SANDWICH

(71) Applicant: Christian Bjorn Bruynseels, Lockport, IL (US)

(72) Inventor: Christian Bjorn Bruynseels, Lockport, IL (US)

(21) Appl. No.: 16/845,339

(22) Filed: Apr. 10, 2020

(51) Int. Cl. A47J 43/28; A23P 20/20

(52) U.S. Cl. CPC A47J 43/283; A23P 20/20

(57) ABSTRACT

A tong device and method of use for holding and dipping a sandwich. The device has opposing biased tong arms and a latticework net suspended between the tong, arms to form a sandwich holding area. The sandwich is held and secured for rotating and dipping the sandwich into a reservoir of au jus liquid.

### (b) CROSS-REFERENCES TO RELATED APPLICATIONS

(Not Applicable)

### (c) STATEMENT REGARDING FEDERALLY-SPONSORED RESEARCH AND DEVELOPMENT

(Not Applicable)

### (d) REFERENCE TO AN APPENDIX”

(Not Applicable)

### (e) BACKGROUND OF THE INVENTION

### 1. Field of The Invention

Generally, the invention relates to tongs. Particularly, the invention relates to tongs for handling and grasping food. Specifically, the invention relates to an improved sandwich handling tong and method of use for ‘wet’ sandwich preparation.

### 2. Background of the Invention

Various types of containers or baskets are used for holding food products. During cooking, for instance, wire form baskets are used for holding various types of food products, such as potatoes, pies, meat products and the like in a deep-frying apparatus. A food-handling tong is used for holding and distributing or serving a prepared food. Tongs are typically utilized as the means for holding prepared food to facilitate additional preparation steps, such as dipping a prepared food into a sauce, a gravy or other seasonings.

The Italian Beef Sandwich is a well-known food item in Chicago, Ill. region and is popularly prepared ‘wet’ by dipping the sandwich surface into an au jus before adding toppings. The sandwich is prepared with seasoned very thinly sliced rump roast stuffed into a sliced crusty French bread roll. After dipping, other condiments can be added.

The problem in the prior art is how the au jus is applied to the sandwich surface. One way is for a preparer to ladle the liquid au jus across the sandwich surface after adding the meat. However, ladling the liquid onto a sandwich results in the liquid draining to the bottom of the sandwich permeating the bread to become soggy at the seam where the slicing of the roll was stopped. The seam becomes soggy, and the roll halves fall apart, and sandwich contents spill from the sandwich, typically requiring the consumer to use utensils.

Another method of making a wet sandwich is for the prepares to hold and rotate the sandwich 180 degrees and dip the sandwich into the pool of liquid au jus. The liquid permeates the bread to which it was dipped. This method seeks to avoid liquid touching the bun seam, so that the bread roll does not disintegrate and retains its structural integrity to then hold a variety of toppings for hand-held consumption.

The problem with this method is that a preparer must hold the sandwich by a tong that is not designed for this process, or to hold the sandwich hand to perform the dipping process. There is no food preparation utensil available for the process. Standard food-handling tongs are damaging to the bread roll and does not cover the sandwich surface. The result is that sandwich meat can fall from the sandwich surface upon rotation and dipping. Hand use is unsanitary, and gloves can be unsanitary and are typically not what a consumer wants touching the food. Also, gloves make the product more slippery and likely to fall from the hands into the pool of au jus.

The present invention solves the problems in the prior art methods of wet sandwich preparation and of dipping prepared foods into liquids, sauces, gravies, cheeses, and seasonings. The present invention resolves the problems with the present methods of dipping or ladling, by providing a novel tong device that allows a secure grasp of the food for further handling. The device provides a method and device for holding and dipping the sandwich surface into au jus its entirety or to a pre-determined depth with precision, without losing sandwich contents and without the preparer touching the sandwich.

### (f) BRIEF SUMMARY OF THE INVENTION

An object, therefore, of the invention is to provide a new and improved sandwich holding tong.

Another object of the invention is to provide a new and improved method for preparing a dipped, wet sandwich, particularly the Italian Beef sandwich well-known in the Chicago, Ill. prepared sandwich market.

In an exemplary embodiment of the invention, the tong includes elongated complementary opposing tong arms extending from a centralized handle end and a latticed net basket suspended between the arms.

As disclosed herein, the device is fabricated with food and heat-safe materials, into an interlaced or mesh form, with smooth surfaces.

Generally, the method of use includes placing a prepared sandwich into the sandwich space of the tong, squeezing the handle to bring the arms inwardly thereby securing the sandwich before it is rotated 180-degrees and dipped into an au Jus or other liquid.

Other objects, features, and advantages of the invention will be apparent from the following detailed description taken in connection with the accompanying drawings.

### (g) BRIEF DESCRIPTION OF THE SEVERAL VIEWS OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a view in perspective of the inventive sandwich holding tong centered above a sandwich.

FIG. 2 is a view in perspective of the inventive sandwich holding tong draped over a sandwich in preparation for lifting, rotating, and dipping the sandwich.

FIG. 3 is a view in perspective of the sandwich dipped in a reservoir of liquid.

FIG. 4 is a view in perspective of the sandwich prepared wet.

FIG. 5 is a block diagram illustrating the steps of an embodiment of the invention.

In describing the preferred embodiment of the invention, which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### (h) DETAILED DESCRIPTION OF THE INVENTION

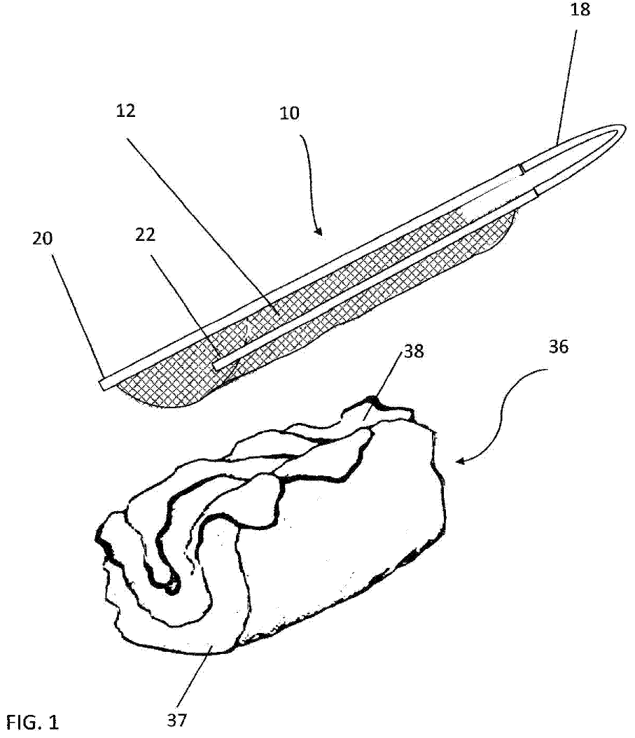

FIG. 1 shows the inventive sandwich-handling tong 10 hovered above a sandwich 36, which has a bread roll 37 and meat contents 38. The tong 10 has a handle 18 with elongated tong gripping arms 20 and 22 extending longitudinally equidistant to each other from the handle 18. The arms 20 and 22 are biased to each other by the handle 18 for pivoting between open and closed positions. The tong 10 has a lattice net 12 structure consisting of a plurality of strips of a material crossed or fastened together resulting in a multiplicity of square or diamond-shaped spaces left between the strips. The lattice net 12 is connected to and supported along the length of the arms 20 and 22.

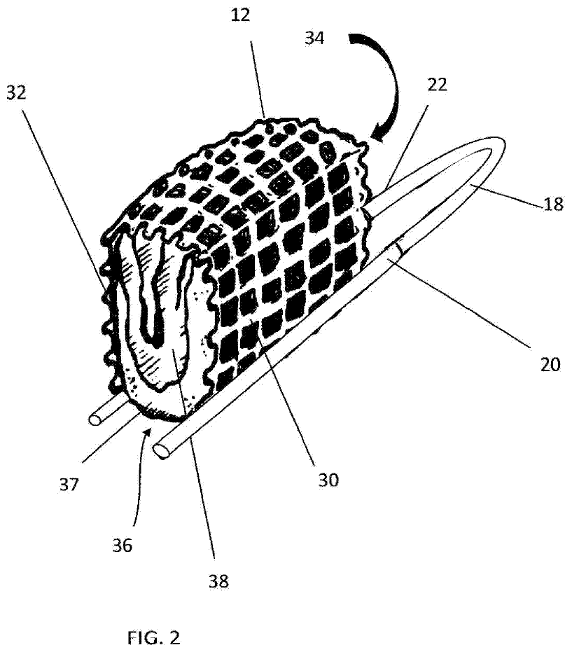

FIG. 2 displays the arms 20 and 22 in contact with respective adjacent sides of the bun 37, with the latticework net 12 draped over the sandwich 36, thereby forming opposing upright side wall portions 30 and 32 and defining a sandwich holding space 34 therewithin. The meat content 38 is secured by the lattice net structure 12, and the sandwich 36 is also secured in the holding space 34.

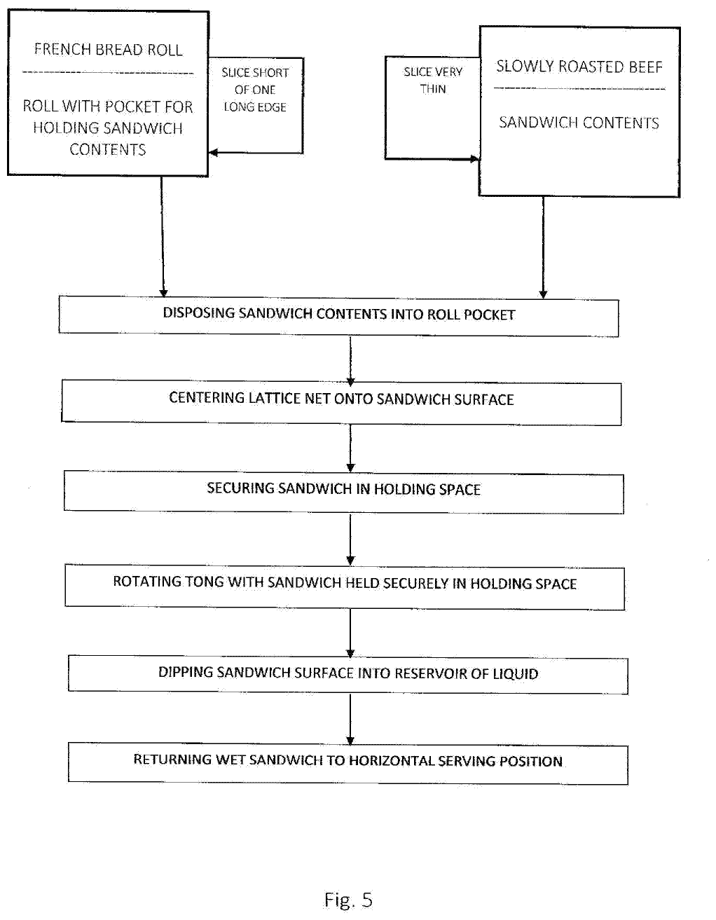

As illustrated in FIG. 5, the method for preparing a wet sandwich using the inventive sandwich-handling tong 10 begins with the user choosing a bread knife with a serrated edge. Next, placing the bread roll flat on a substantially horizontal surface, such as a cutting board, followed by placing a free hand on top of the bread roll to hold it steady. Then, lacing the knife to a long side edge of the roll and sawing back and forth across the bread roll to a position just short of the other long side edge of the roll. Spreading the split roll halves open allows the roll portions to define a pocket for holding sandwich contents.

The next step in the dipped Italian Beef sandwich preparation process using the present invention is providing slowly cooked rump roast sliced very thin for the contents 38 as shown in FIGS. 1 and 2. The slices are disposed into the pocket of the sliced bread roll 37, which typically means the slices are placed between the sliced bread roll side to side, stacked, layered, and pushed together until breaking the plane of the outer surface of the bread roll 37. The preferred bread roll to use is the French bread roll, which has a tough outer crust that retains structural integrity when permeated with the au jus.

Next, the user grasps the handle 18 and lifts the tong 10 above and overtop the sandwich, placing the lattice net 12 centered over the surface of the sandwich, as shown in FIG. 1. The net 12 is aligned hovered substantially centered over the sandwich, with the arms 20 and 22 substantially parallel to and equidistant to adjacent sides of the sandwich 36.

Then the lattice net 12 is lowered onto the sandwich and the handle 18 is squeezed to bring each arm 20 and 22 into contact with the respective side of the sandwich, as shown in FIG. 2. The net lattice 12 is smooth and does not damage the surface of the bread roll 37 upon contact. The user squeezes the handle 18 with enough force to hold the sandwich 36 securely during further preparation.

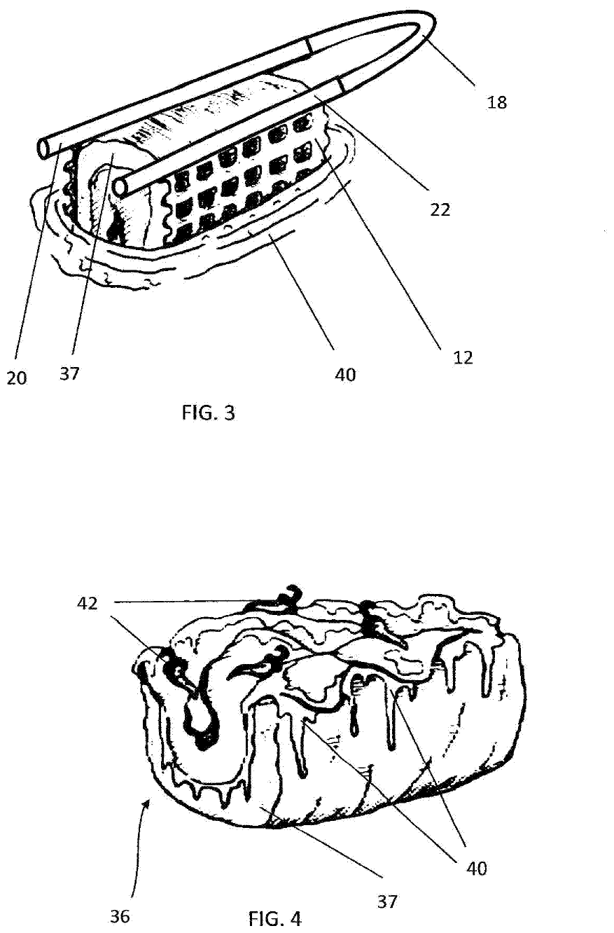

As displayed in FIG. 3, the sandwich 36 is rotated 180 degrees and dipped into a prepared reservoir of au jus 40 to a pre-determined depth for allowing the au jus to permeate the bread 37. The sandwich 36 is subsequently lifted out of the liquid 40, rotated one hundred and eighty degrees and placed horizontally, and the tong 10 is removed and set aside for washing or re-using. FIG. 4 shows the sandwich 36 prepared with the bread roll 37 wet from dipping into the au jus liquid 40. Peppers 42 are added as a further ingredient.

In an alternative embodiment of the invention (not shown), a net can be a mesh structure which utilizes interlaced strips of material, such as a stainless-steel mesh. In any embodiment, the material used for the invention must be non-toxic for use with food, as well as heat resistant and washable as is common for materials used the manufacture of food-handling materials.

It is of course to be understood that the embodiments described herein are merely illustrative of the principles of the invention and that a wide variety of modifications thereto may be effected by persons skilled in the art without departing from the spirit and scope of the invention as set forth in the following claims.

I claim:

1. Tongs for grasping a sandwich, said tongs including:
a handle;
a pair of elongated tong arms connected to said handle and extending substantially parallel to each other outwardly from said handle, said handle biasing said tong arms being to pivot between an open position and a closed position;
a latticework net connected to said tongs and suspended between said arms,
wherein said closed position of said tong arms forms opposing latticework net side wall portions defining a sandwich holding space therewithin.

2. A method for preparing a wet sandwich, comprising the steps of
(a) choosing a bread knife with a serrated edge;
(b) placing a bread roil flat on a substantially horizontal surface, such as a cutting board;
(c) placing a free hand on top of said bread roll to hold it steady;
(d) placing the knife to a long side edge of said roll and sawing back and forth across said roll to a position just short of the other long side edge of said roll;
(e) spreading the split roll halves open to allow said roll portions to define a pocket for holding sandwich content
(f) providing slowly cooked rump roast sliced very thin for said sandwich contents;
(g) disposing said sandwich contents into said pocket of said roll;
Providing tongs for grasping a sandwich, said tongs including:
a handle;
a pair of elongated tong arms connected to said handle and extending substantially parallel to each other outwardly from said handle, said handle biasing said tong arms being to pivot between an open position and a closed position;
a latticework net connected to said tongs and suspended between said arms,
wherein said closed position of said tong arms forms opposing latticework net side wall portions defining a sandwich holding space therewithin;
(h) grasping said handle;
(i) lifting said tong above and overtop said sandwich;
(j) aligning said latticework substantially centered over said sandwich with said arms substantially equidistant from the respective longitudinal sides of said sandwich,
(k) lowering said latticework net into contact with said sandwich, whereby said sandwich occupies said sandwich holding space;
(l) squeezing said handle to pivotally move said arms into securing contact with adjacent sides of said sandwich;
(m) lifting and rotating said sandwich 180 degrees over a pool of au jus;
(n) lowering said sandwich into said pool of au jus to a pre-determined depth for allowing the au jus to permeate said roll bread roll;
(o) lifting said sandwich from said pool;
(p) rotating said sandwich 180 degrees;
(q) placing said sandwich horizontal;
(r) relaxing said tong arms to an open position;
(s) lifting the tongs and latticework net from said sandwich.
